(19) United States
(12) Patent Application Publication
(10) Pub. No.: US 2017/0228459 A1
(43) Pub. Date: Aug. 10, 2017

(54) METHOD AND DEVICE FOR MOBILE SEARCHING BASED ON ARTIFICIAL INTELLIGENCE

(71) Applicant: BEIJING BAIDU NETCOM SCIENCE AND TECHNOLOGY CO., LTD., Beijing (CN)

(72) Inventors: Haifeng WANG, Beijing (CN); Shiqi ZHAO, Beijing (CN); Haifeng WU, Beijing (CN); Tian WU, Beijing (CN); Daisong GUAN, Beijing (CN)

(21) Appl. No.: 15/384,141

(22) Filed: Dec. 19, 2016

(30) Foreign Application Priority Data
Feb. 5, 2016 (CN) 201610082553.5

(51) Int. Cl. G06F 17/30; G06N 99/00

(52) U.S. Cl. CPC G06F 17/30864; G06N 99/005

(57) ABSTRACT

A method and a device for mobile searching based on artificial intelligence are provided in the present disclosure. The method includes: displaying a search box, and receiving a query inputted by a user via the search box; obtaining a search result according to the query, and displaying the search result on a search result page; after receiving a click instruction on the search result, displaying a context page corresponding to the search result; and after receiving a click instruction on a result in the search result or in the context page, displaying a content page corresponding to the result clicked. The method can break through the concept of PC search and provide a search method which is more suitable for a mobile search scene.

### CROSS-REFERENCE TO RELATED APPLICATIONS

This application claims priority to and benefit of Chinese Patent Application Serial No. 201610082553.5, filed with the State Intellectual Property Office of P. R. China on Feb. 5, 2016.

### FIELD

The present disclosure relates to internet technology field, and more specifically to a method and a device for mobile searching based on artificial intelligence.

### BACKGROUND

Artificial Intelligence (AI) is a new technology science for researching and developing a theory, a method, a technology and an application system configured to simulate, extend and expand human intelligence. The AI is a branch of computer science, and it attempts to understand the essence of intelligence and produces a new intelligence machine which can react in a way similar to human intelligence. The research of the field includes a robot, language recognition, image recognition, natural language process and an expert system etc.

As a rapid popularization of smart cellphones, mobile internet has become a main route to obtain information for most of network users. Accordingly, mobile search instead of personal computer (PC) search becomes a main method of search engine. Influenced by mobile device factors and user habits factors etc., there is a large difference between the mobile search and the PC search.

In the related art, the concept of PC search is still used in the mobile search, such that the mobile search in the related art may be obvious deficient in aspects of meeting a precision, scene and personalization for the search result and attraction of extending the user demand etc.

### SUMMARY

The present disclosure seeks to solve at least one of the problems existing in the related art to at least some extent.

Therefore, one objective of the present disclosure is to provide a method for mobile searching based on artificial intelligence, which may break through the concept of PC search and provide a search method which is more suitable for a mobile search scene.

Another objective of the present disclosure is to provide a device for mobile searching based on artificial intelligence.

In order to realize the above objectives, according to the first aspect of embodiments of the present disclosure, a method for mobile searching based on artificial intelligence is provided. The method includes:

displaying a search box, and receiving a query inputted by a user via the search box;

obtaining a search result according to the query, and displaying the search result on a search result page;

after receiving a click instruction on the search result, displaying a context page corresponding to the search result; and

after receiving the click instruction on a result in the search result or in the context page, displaying a content page corresponding to a clicked result.

The method for mobile searching based on artificial intelligence provided in the first aspect of the present disclosure may provide a search method which is more suitable for the mobile search according to the process described above.

In order to realize the above objectives, according to a second aspect of embodiments of the present disclosure, a device for mobile searching based on artificial intelligence is provided. The device includes:

a first display module, configured to display a search box and to receive a query inputted by a user via the search box;

a second display module, configured to obtain a search result according to the query and to display the search result on a search result page;

a third display module, configured to display a context page corresponding to the search result after receiving a click instruction on the search result; and

a fourth display module, configured to display a content page corresponding to a clicked result after receiving the click instruction on a result in the search result or in the context page.

The device for mobile searching based on artificial intelligence provided in the second aspect of the present disclosure may provide a search method which is more suitable for the mobile search according to the process described above.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

The above-described and/or other aspects and advantages of embodiments of the present disclosure will become apparent and more readily appreciated from the following descriptions made with reference to the drawings, in which:

FIG. 1 is a flow chart of a method for mobile searching based on artificial intelligence according to an embodiment of the present disclosure;

FIG. 2 is a schematic diagram of various pages according to embodiments of the present disclosure;

FIGS. 3a-3b are schematic diagrams of pages corresponding to a single demand query and a multi-demand query respectively according to embodiments of the present disclosure;

FIGS. 4a-4d are schematic diagrams of search result pages of a specific embodiment according to embodiments of the present disclosure;

FIG. 5 is a schematic diagram of a context page of a specific embodiment according to embodiments of the present disclosure;

FIG. 6 is a schematic diagram of a content page of a specific embodiment according to embodiments of the present disclosure;

FIGS. 7a-7b are schematic diagrams of search result pages of another specific embodiment according to embodiments of the present disclosure;

FIGS. 8a-8c are schematic diagrams of a search result page, a context page and a content page respectively of another specific embodiment according to embodiments of the present disclosure;

FIG. 9 is a flow chart of obtaining a search result according to a query according to embodiments of the present disclosure;

FIG. 10 is another flow chart of obtaining a search result according to a query according to embodiments of the present disclosure;

FIG. 11 is another flow chart of obtaining a search result according to a query according to embodiments of the present disclosure;

FIG. 12 shows an effect schematic diagram corresponding to the mobile search according to embodiments of the present disclosure;

FIG. 13 shows a structure schematic diagram of a device for mobile searching based on artificial intelligence according to another embodiment of the present disclosure; and

FIG. 14 shows a structure schematic diagram of a device for mobile searching based on artificial intelligence according to another embodiment of the present disclosure.

### DETAILED DESCRIPTION

Reference will be made in detail to embodiments of the present disclosure, so as to make objectives, technical solutions and advantages of the present disclosure clearer. It should be understood that, embodiments described herein are only used to explain the present disclosure, but not used to limit the present disclosure. In addition, it should be noted that, for sake of description, part of content related to the present disclosure is illustrated in the drawings, but not all the content.

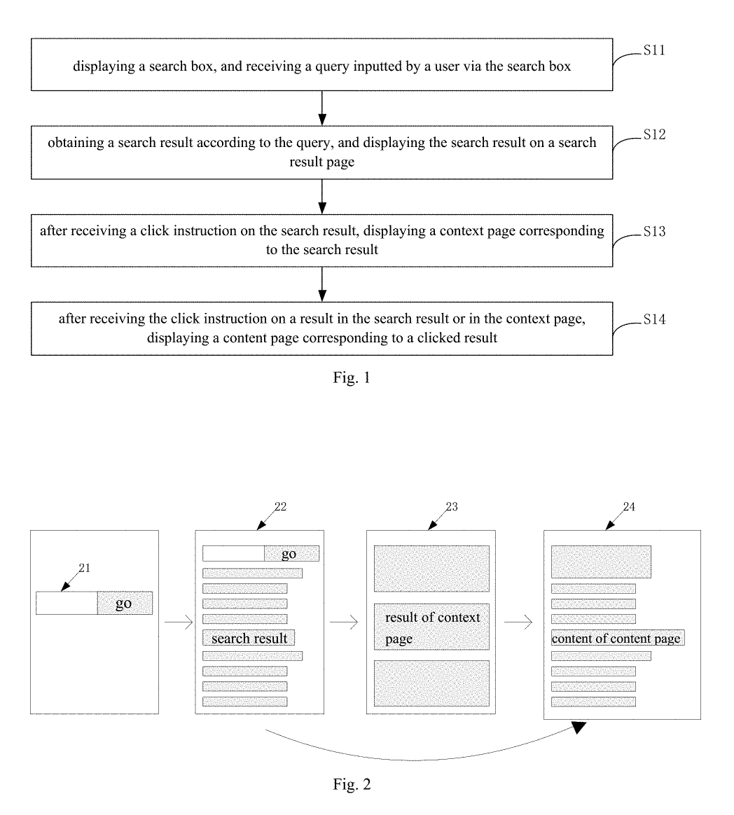

FIG. 1 is a flow chart of a method for mobile searching based on artificial intelligence according to an embodiment of the present disclosure.

Referring to FIG. 1, the method includes steps as follows.

S11, displaying a search box, and receiving a query inputted by a user via the search box.

As shown in FIG. 2, when the user uses a search product (such as a mobile Baidu), the search box 21 may be first displayed to the user.

The user may input the query in the search box so as to finish a corresponding search.

When inputting the query by the user, the query may be inputted in form of characters, voice and pictures and the like.

S12, obtaining a search result according to the query, and displaying the search result on a search result page.

For example, referring to FIG. 2, when a user inputs the query in the search box 21 and clicks “go”, then the page will go to the search result page 22, which includes the search result.

In some embodiments, the search result may include: a precise result, an aggregate result and a recommendation guide result.

If the query is a single demand query, the precise result which meets the demand is directly provided.

If the query is a multi-demand query, the search results under the multi-demand are aggregated, and then the aggregate result is provided.

If the query is a single demand query, after the precise result, one or more recommendation guide results related to the demand (query), the precise result and personalization and scene for the user are provided. Or, when the query is a multi-demand query, after the aggregate result, one or more recommendation guide results related to the demand (query), one or more of the precise results and the personalization and scene for the user are provided.

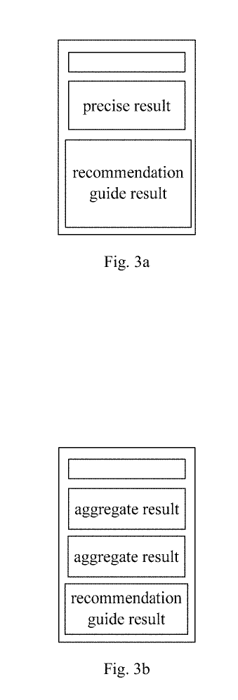

For example, referring to FIGS. 3a-3b, FIGS. 3a-3b are schematic diagrams of pages corresponding to the single demand query and the multi-demand query respectively according to embodiments of the present disclosure.

S13, displaying a context page corresponding to the search result after receiving a click instruction on the search result.

The context page is configured to provide a context for deep reading and browsing for the user interested in a given context. The content in the context page is a refining or extending for the given context, including a similar result, an approximate result or a related result of the given result. The given result is one result of the search results.

For example, referring to FIG. 2, when the user clicks a search result in the search result page, the context page 23 corresponding to the clicked search result is displayed.

S14, displaying a content page corresponding to a clicked result after receiving the click instruction on a result in the search result or in the context page.

The content in the content page is a detailed content of a result in the search result page, or a detailed content of a result in the context page, which includes but not limited to: a detailed report of news, a detailed description of an object, and a detailed content of a webpage etc.

For example, referring to FIG. 2, after the user clicks a result in the context page, a content page 24 corresponding to the clicked result is displayed, or after the user clicks a result in the search result page, the content page 24 corresponding to the clicked result is displayed.

Specific embodiments are described for illustrating the above process as follows.

In some embodiments, a mobile search of single demand query is regarded as an example.

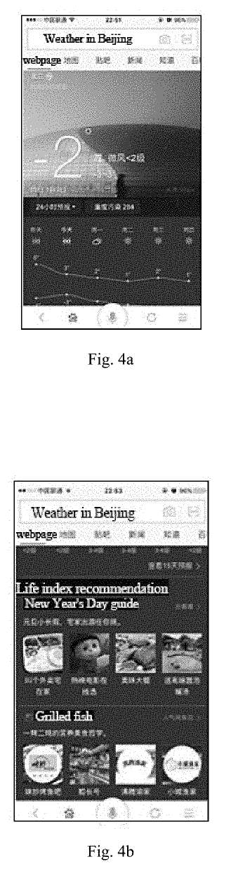

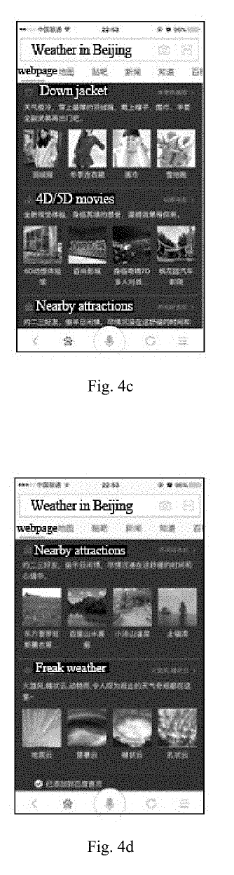

For example, the single demand query is “Weather in Beijing”. After the user inputs “Weather in Beijing” in the search box and starts a search, search result pages are shown in FIGS. 4a-4d.

It could be understood that, limited to the size of the mobile device, the search result is usually displayed in a format of multi-screens, and the user may see the search result of different screens by sliding up and down. Four screens in FIGS. 4a-4d are regarded as examples in the present disclosure.

The search result may include a precise result which satisfies the query demand directly as shown in FIG. 4a, and also may include a recommendation guide result as shown in FIGS. 4b-4d. In the present embodiment, the recommendation guide result is “Life index recommendation”, specifically including specific context like “New Year's Day guide”, “Grilled fish”, “Down jacket”, “4D/5D movies”, “Nearby attractions”, “Freak weather”.

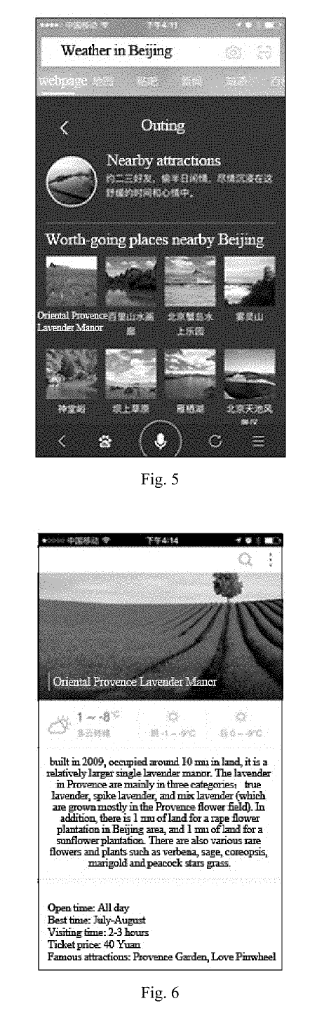

Taking the search result of “Nearby attractions” as an example, the search result is corresponding to a context page, i.e. after the user clicks “Nearby attractions”, the context page shown in FIG. 5 will be displayed. The nearby attractions displayed in the context page are more detailed and more comprehensive than those displayed in the search result page.

Taking clicking the result in the context page as an example, for example, after the user clicks the result of “Oriental Provence Lavender Manor” in the context page, the content page corresponding to the clicked result will be displayed as shown in FIG. 6.

In some embodiments, a mobile search of multi-demand query is regarded as an example.

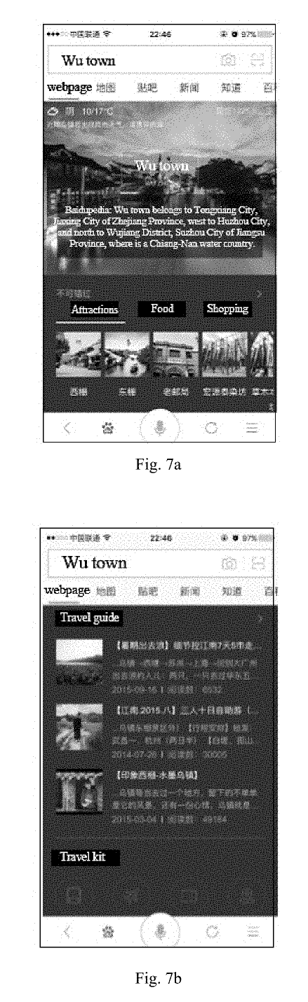

For example, the multi-demand query is “Wu town”. After the user inputs “Wu town” in the search box and starts a search, the search result page as shown in FIGS. 7a-7b may be displayed.

In the present embodiment, since the user has multiple potential demands on the object of “Wu town”, a demand distribution of the user under the current query is automatically detected, multi-demand dimensions like “Attractions”, “Food”, and “Shopping” are extracted, and the search results are aggregated and displayed according to the demand dimensions. For example, referring to FIG. 7a, an aggregate result aggregating demand dimensions like “Attractions”, “Food”, and “Shopping” will be displayed. In addition, the recommendation guide result as shown in FIG. 7b may also be displayed in the search result page.

In the scene of the multi-demand query, the principle and logic of the context page and the content page are in accordance with those of the single demand query, which shall not be elaborated herein.

Further, in a scene of multi-demand query, a kind of multi-demand query is an ambiguity query, such as “apple”, “Lina”. The demand for the user may be distributed in different items regarding to the kind of multi-demand query, e.g. the demand for “apple” may be a fruit, a cellphone brand, a name of a company, and a movie etc., in this case, the present disclosure may display the aggregate results under different items.

In some embodiments, a mobile search of an information query is regarded as an example.

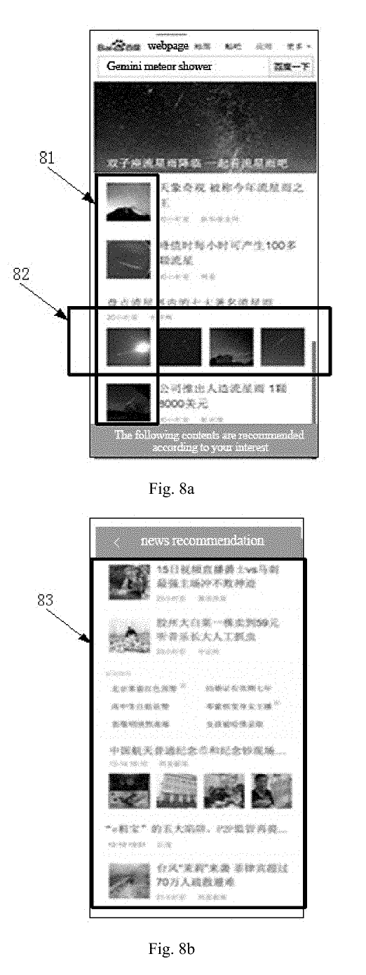

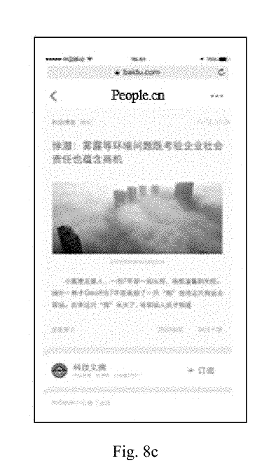

For example, the information query is “Gemini meteor shower”. After the user inputs the “Gemini meteor shower” in the search box and starts the search, the search result page as shown in FIG. 8 may be displayed.

The search result page includes a precise result that satisfies the demand of the query directly, and displays a recommendation guide result beneath the precise result. If the user has a further demand on reading and browsing information, the recommendation guide result may be clicked to enter the context page as shown in FIG. 8b, the choosing of the information content for the context page is mainly based on popularity, timeliness and relevancy to a personalized demand of the user of the information content. If the user needs to acknowledge some information in the context page in detail, the information may be clicked to enter to the content page as shown in FIG. 8c.

In the above process, for obtaining the search result according to the query, different methods may be used according to different scenes.

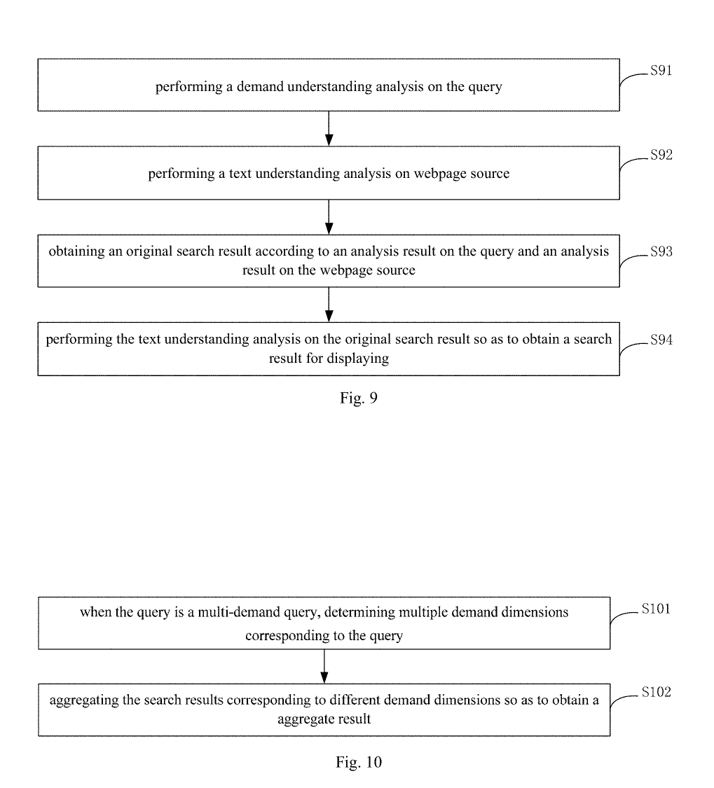

In some embodiments, referring to FIG. 9, the process for obtaining the search result according to the query includes steps as follows.

S91: performing a demand understanding analysis on the query.

The demand understanding analysis may include: a demand classification, a demand syntactic analysis and a demand semantic analysis.

The demand classification classifies the query (Q) as a certain category based on a given demand classification system, such as classifying Q=“Weather in Shanghai tomorrow” as a category of “weather”.

The demand syntactic analysis analyzes the relationship between the words in Q, such as for Q=“Weather in Shanghai tomorrow”, a keyword of the demand is analyzed to be “weather”, and the determiners are “tomorrow” and “Shanghai” respectively.

The demand semantic analysis further analyzes and generates a syntactic expression according to the result of the demand classification and the demand syntactic analysis, so as to perform a search in a knowledge library.

Further, the demand understanding analysis further includes: demand normalization, and/or search error correction.

For some query which is not popularly used, the demand normalization technology needs to be applied, e.g. Q=“Do you know how is the weather in Shanghai tomorrow” is a colloquial query, which is equal to “Weather in Shanghai tomorrow” semantically, and it may further be normalized based on the current date to a format of the precise search like “Jan. 12, 2016 Shanghai Weather”.

For a query including an error, the search error correction technology needs to be used, e.g. Q=“Weather in Xhanghai tomorrow”, the search error correction technology needs to automatically recognize that a possible input error “Xhanghai” in the query should be “Shanghai”, and change it to a correct query “Weather in Shanghai tomorrow”.

S92: performing a text understanding analysis on webpage source. performing a text understanding analysis on webpage source includes a text subject analysis.

The text subject analysis technology: a subject distribution of an arbitrary given webpage text is calculated based on a training subject module of a large scale webpage and then the subject model. For an easy example, the subject distribution of a webpage may be: Politics: 0.74; Military affairs: 0.21; Economy: 0.05 (it should be noted that each number indicates a distribution probability of the text on each subject). The text subject analysis technology is configured to improve subject correlation of the search results.

S93: obtaining an original search result according to an analysis result on the query and an analysis result on the webpage source.

For example, after performing a demand analysis on the query, the query is determined as belonging to the Politics subject, and then may be searched in the webpage source with a higher distribution probability of the Politics subject to obtain the corresponding search result as the original search result.

S94: performing the text understanding analysis on the original search result so as to obtain a search result for displaying.

Performing the text understanding analysis on the original search result includes: performing an automatic abstract processing on the original search result. The automatic abstract technology: limited by a text length of the search result, the automatic abstract usually needs to be generated for the search result, and the generated abstract is displayed to the user so as to improve the reading efficiency for the user.

In some embodiments, when the query is a question, a precise answer corresponding to the question is obtained using a deep question answering.

The deep question answering technology is configured to provide a precise answer aiming at a question-type search of the user. The deep question answering technology may be divided into types according to the answer types as follows: (1) an entity-type question and answer, i.e. the expected answer to the question is one or more entities, such as “the largest country in the South America”, and “which food can supply calcium”; (2) a Yes/No type question and answer, i.e. the expected answer to the question is a determination of “yes” or “no”, such as “can a baby eat a sea slug”, and “whether a down jacket can be washed by water”; and (3) a paragraph-type question and answer, such as “how to deal with hiccups of a baby”, and “how to cook a red-cooked pork”. The deep question answering technology obtains an answer from the big data of the internet via automatic mining, filtering, summarizing and sorting based on an automatically analysis of the question demand and types.

In the deep question answering technology, except for answering objective questions, subjective questions are needed to be answered, such as “how is MA K5”, “Is Da Dong roast duck delicious”, the answer to this type of questions needs to be based on an emotional analysis technology, comment opinions for each aspect of comment obtained by an automatic analysis from the comment texts of the above comment object to be commented and the abstract of a comment sentence automatically generated. For example, for the query “how is MA K5”, the mining of the comment opinions (“good”, “bad”, “ordinary” etc.) need to be performed aiming at the aspects such as “appearance”, “fuel consumption”, “interior”, and “operability” respectively, a comment abstract sentence is generated based on a large number of comment sentences online around each of the comment opinions for each of the aspects.

In some embodiments, referring to FIG. 10, the process of obtaining the search result according to the query includes steps as follows.

S101, determining multiple demand dimensions corresponding to the query when the query is a multi-demand query.

S102, aggregating the search results corresponding to different demand dimensions so as to obtain an aggregate result.

Specifically, when the query is the multi-demand query, a result aggregate technology is used.

The result aggregate technology is configured to automatically discover the demand dimensions for the multi-demand query and to aggregate the search results in different search dimensions. The result aggregate technology specifically includes: (1) discovering the demand dimensions: performing an automatic clustering on all the query containing a current query Q according to the demand dimensions based on a user search log; i.e. for Q=“Lijiang”, different demand dimensions like “guide”, “food”, “attractions” need to be discovered automatically. There are several specific technologies of discovering the demand dimensions, a common methods are calculating the clustering based on a query content similarity and clustering based on a user click similarity (i.e. for the queries with the same demand, the same results tend to be clicked) etc.; (2) aggregating the search results: for a multi-demand query Q, aggregating all the search results in the above discovered multiple demand dimensions. Specifically, the aggregate process considers not only a correlation between each search result and each demand dimension, but also considers the similarity between the search results. For example, for a search result to a subject of “local snacks in Lijiang” under Q=“Lijiang”, the search results are aggregated by calculating correlation between the results and the demand dimensions such as “guide”, “food”, “attractions”, and also calculating a similarity between the search result and each search result that has been aggregated in each demand dimension.

Further, the multi-demand query includes an ambiguous query, and the ambiguous query is a query corresponding to multiple items. For example, the query “apple” may be corresponding to multiple items like a fruit, an electronic product, a company and a movie.

At this time, the multiple demand dimensions refer to multiple items, such that the search results corresponding to the multiple items are aggregated so as to obtain an aggregate result.

Specifically, when the query is the ambiguous query, a disambiguation technology may be used.

The disambiguation technology is configured to aggregate the search results corresponding to different items according to an ambiguous query Q. An underlying technology is an entity linking technology. Specifically, a literal expression (e.g. “apple”) of the ambiguous query Q is corresponding to multiple items (e.g. “apple” is corresponding to “fruit”, “electronic product”, “company” and “movie” etc.) in a preset knowledge library. The entity linking technology realizes a correct link to a different item by building a model on the context of the ambiguous expression Q in each search result. For example, for a result “more apples should be eaten in winter for vitamin supplementation”, by building a model on the context of the query “apple”, the item “fruit” may be automatically been linked to, but for a result of “Jobs creates a new era for Apple”, the item “company” may be linked to.

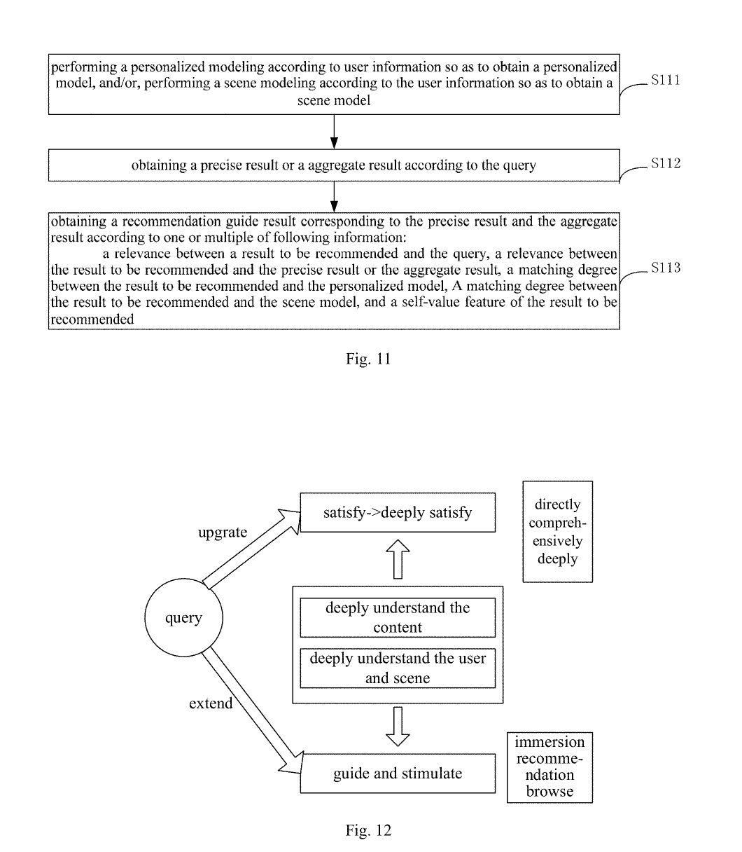

In some embodiments, referring to FIG. 11, the method includes steps as follows. S111, performing a personalized modeling according to user information so as to obtain a personalized model, and/or, performing a scene modeling according to the user information so as to obtain a scene model.

The user information used in the personalized modeling includes but not limited to: an attribute, a status, an interest, and a consumption habit for a user.

Specifically, the personalized modeling includes a modeling on the attribute (e.g. gender and age etc.), the status (e.g. pregnant, pursuing a job etc.), the interest (e.g. interested in horrible movie and rock music etc.), the consumption habit (e.g. usually shopping the electric products etc.) for the user. The modeling method may include but not limited to: actively filling and submitting personalized information by the user, automatically analyzing search logs of the user, and automatically analyzing whole-page browsing logs of the user etc. It should be noted that, the information obtained by personalized modeling will be used for the personalized search and personalized recommendation for the user itself, not for other uses, so as to ensure the user's privacy.

The user information used in the scene modeling includes but not limited to: a time, a location, an occasion, a context, and a terminal used and the like when the user starts the query.

Specifically, the scenic characters need to be obtained include the time, the location (based on different geographic mapping), the occasion (e.g. a school, a shopping center, a residential area etc.), the context (other queried searched before the current query), and the terminal (e.g. smart phones with different brands) when the user starts the query.

Accordingly, the process of obtaining the search result according to the query includes steps as follows.

S112, obtaining a precise result or an aggregate result according to the query.

The precise result or the aggregate result is a result satisfying the demand of a single query or a multi-dimensional query. Not only the result satisfying the user's demand may be displayed on the search result page, but also a related recommendation guide result is displayed.

S113, obtaining a recommendation guide result corresponding to the precise result and an aggregate result according to one or multiple of the following information:

a relevance between a result to be recommended and the query, a relevance between the result to be recommended and the precise result or the aggregate result, a matching degree between the result to be recommended and the personalized model, a matching degree between the result to be recommended and the scene model, and a self-value feature of the result to be recommended.

Specifically, as shown above, after displaying the precise result or the aggregate result, the recommendation guide result may be further displayed so as to stimulate the potential search demand. For any result D to be recommended, a recommendation value of which is calculated based on the recommendation guide technology, and then it is determined whether or not to recommend the result according to the value: (1) a relevance between the result D to be recommended and a query Q, (2) a relevance between the search results of D and Q, (3) a matching degree between D and a current personalized model of the user, (4) a matching degree between D and a scene model of the current query Q, and (5) a self-value feature of D, such as an authority and a timeliness.

In the present embodiment, according to the above process, the objective of the search engine may be changed fundamentally, and “satisfying the user's demand quickly” is improved into “deeply satisfying the user's demand, and an ‘immersion’ experience is provided for the user”, as shown in FIG. 12. Specifically, the following contents are included.

Deeply satisfying the user's demand is embodied in following aspects: (1) satisfying the single demand more precisely, providing a precise answer to the user rather than a link to a web page, such that a time cost on further browsing the website and seeking the answer may be omitted; (2) covering the user's demands more comprehensively, especially for a multi-demand query, mining a demand distribution and the respective priority under the query, displaying the search result comprehensively and reasonably, such that covering the search demands for the user to the utmost degree; and (3) satisfying the search demand more deeply, and improving the depth and quality of the search result based on a choice resource with good quality and technical means on the aggregate, abstract and knowledge mining etc.

An immersion search experience is embodied in the following aspects: (1) on the basis of satisfying the search demand, strengthening a demand guide, and stimulating an extended search demand for the user; (2) based on the personalized and scene modeling, refining the pertinence and dependency of the guide and stimulation, such that the attraction of the recommended contents are improved; and (3) changing an “toolization” attribute of a traditional search engine, enforcing the “immersion” experience, i.e. that the user may not only use the search engine for searching, but also may be immersed in, reading information or comprehensively obtaining various information with high quality.

Specifically, the fundamental innovation of the representation for the search result is transforming a “one-dimensional” representation method of a linear ordering from high to low simply according to the relevance of the traditional search results into a “three-dimensional” representation method of “vertical+traverse+depth”. The so-called “vertical” means a vertical arrangement (as shown in the first box-selected content 81 in FIG. 8a) on the search results from up to down according to factors of the relevance and importance; the “traverse” means a traverse arrangement (as shown in the second box-selected content 82 in FIG. 8a) on the similar search results satisfying the same demands from left to right; and “depth” means a progress and extension (as shown in the third box-selected content 83 in FIG. 8a) on the current search result displayed in the context page.

In conclusion, the above mobile search solution mentioned in the present disclosure may extend a using duration of a user on the basis of improving the user's satisfaction. The improvement on the user's experience will bring stronger ecological control on the mobile searching.

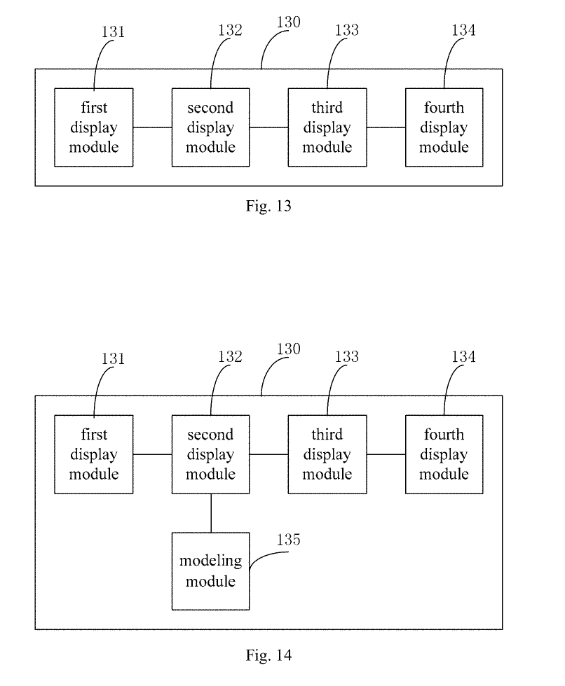

FIG. 13 shows a structure schematic diagram of a device for mobile searching based on artificial intelligence according to another embodiment of the present disclosure. Referring to FIG. 13, the device 130 includes: a first display module 131, a second display module 132, a third display module 133 and a fourth display module 134.

The first display module 131 is configured to display a search box, and to receive a query inputted by a user via the search box.

The second display module 132 is configured to obtain a search result according to the query, and to display the search result on a search result page.

The third display module 133 is configured to display a context page corresponding to the search result after receiving a click instruction on the search result.

The fourth display module 134 is configured to display a content page corresponding to a clicked result after receiving the click instruction on a result in the search result or in the context page.

In some embodiments, the search result includes:

a precise result, an aggregate result and a recommendation guide result.

In some embodiments, the second display module 132 obtains a search result according to the query by:

performing a demand understanding analysis on the query;

performing a text understanding analysis on webpage source;

obtaining an original search result according to an analysis result on the query and an analysis result on the webpage source; and

performing the text understanding analysis on the original search result so as to obtain a search result for displaying.

In some embodiments, the demand understanding analysis includes:

a demand classification, a demand syntactic analysis and a demand semantic analysis.

In some embodiments, the demand understanding analysis further includes:

a demand normalization, and/or a search error correction.

In some embodiments, performing the text understanding analysis on the webpage source includes:

performing a text subject analysis on the webpage resource.

In some embodiments, performing the text understanding analysis on the original search result includes:

performing an automatic abstract processing on the original search result.

In some embodiments, the second display module 132 being configured to obtain a search result according to the query including:

when the query is a question, obtaining a precise answer corresponding to the question using a deep question answering.

In some embodiments, the second display module 132 obtains a search result according to the query by:

when the query is a multi-demand query, determining multiple demand dimensions corresponding to the query; and

aggregating the search results corresponding to different demand dimensions so as to obtain an aggregate result.

In some embodiments, referring to FIG. 14, the device further includes:

a modeling module 135, configured to perform a personalized modeling according to user information so as to obtain a personalized model, and/or, to perform a scene modeling according to the user information so as to obtain a scene model.

Accordingly, the second display module 132 being configured to obtain a search result according to the query including:

obtaining a precise result or an aggregate result according to the query;

obtaining a recommendation guide result corresponding to the precise result and the aggregate result according to one or more of the following information:

a relevance between a result to be recommended and the query, a relevance between the result to be recommended and the precise result or the aggregate result, a matching degree between the result to be recommended and the personalized model, a matching degree between the result to be recommended and the scene model, and a self-value feature of the result to be recommended.

The above-described device is corresponding to the method, the specific contents of each module in the device may refer to the corresponding description in the method embodiments, which shall not be elaborated herein.

In the present embodiments, according to the above process, the objective of the search engine may be changed fundamentally, thereby improving from “satisfying the user's demand quickly” into “deeply satisfying the user's demand, and providing an ‘immersion’ experience for the user”.

It should be noted that, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, which may not follow a shown or discussed order according to the related functions in a substantially simultaneous manner or in a reverse order, to perform the function, which should be understood by those skilled in the art.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discreet logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for mobile searching based on artificial intelligence, comprising:
displaying a search box, and receiving a query inputted by a user via the search box;
obtaining a search result according to the query, and displaying the search result on a search result page;
displaying a context page corresponding to the search result after receiving a click instruction on the search result; and
displaying a content page corresponding to a clicked result after receiving a click instruction on a result in the search result or in the context page.

2. The method according to claim 1, wherein the search result comprises:
a precise result, an aggregate result and a recommendation guide result.

3. The method according to claim 1, wherein obtaining the search result according to the query comprises:
performing a demand understanding analysis on the query;
performing a text understanding analysis on webpage source;
obtaining an original search result according to an analysis result on the query and an analysis result on the webpage source; and
performing the text understanding analysis on the original search result so as to obtain a search result for displaying.

4. The method according to claim 3, wherein the demand understanding analysis comprises:
a demand classification, a demand syntactic analysis and a demand semantic analysis.

5. The method according to claim 4, wherein the demand understanding analysis further comprises:
a demand normalization, and/or a search error correction.

6. The method according to claim 3, wherein performing the text understanding analysis on the webpage source comprises:
performing a text subject analysis on the webpage resource.

7. The method according to claim 3, wherein performing the text understanding analysis on the original search result comprises:
performing an automatic abstract processing on the original search result.

8. The method according to claim 1, wherein obtaining the search result according to the query comprises:
obtaining a precise answer corresponding to a question using a deep question answering when the query is the question.

9. The method according to claim 8, wherein the question comprises an objective question and a subjective question,
when the question is the subjective question, a comment abstract sentence is extracted from a comment text as an answer using an emotion analysis.

10. The method according to claim 1, wherein obtaining the search result according to the query comprises:
determining multiple demand dimensions corresponding to the query when the query is a multi-demand query; and
aggregating the search results corresponding to the different demand dimensions so as to obtain an aggregate result.

11. The method according to claim 10, wherein the multi-demand query comprises an ambiguous query and the multiple demand dimensions comprise multiple items, such that the search results corresponding to the multiple items are aggregated so as to obtain the aggregate result.

12. The method according to claim 1, further comprising:
performing a personalized modeling according to user information so as to obtain a personalized model, and/or, performing a scene modeling according to the user information so as to obtain a scene model;
wherein obtaining the search result according to the query comprises:
obtaining a precise result or an aggregate result according to the query;
obtaining a recommendation guide result corresponding to the precise result or the aggregate result according to one or more of information:
a relevance between a result to be recommended and the query, a relevance between the result to be recommended and the precise result or the aggregate result, a matching degree between the result to be recommended and the personalized model, a matching degree between the result to be recommended and the scene model, and a self-value feature of the result to be recommended.

13. A device for mobile searching based on artificial intelligence, comprising:
a first display module, configured to display a search box, and to receive a query inputted by a user via the search box;
a second display module, configured to obtain a search result according to the query, and to display the search result on a search result page;
a third display module, configured to display a context page corresponding to the search result after receiving a click instruction on the search result; and
a fourth display module, configured to display a content page corresponding to a clicked result after receiving a click instruction on a result in the search result or in the context page.

14. The device according to claim 13, wherein the search result comprises:
a precise result, an aggregate result and a recommendation guide result.

15. The device according to claim 13, wherein the second display module obtains a search result according to the query by:
performing a demand understanding analysis on the query;
performing a text understanding analysis on webpage source;
obtaining an original search result according to an analysis result on the query and an analysis result on the webpage source; and
performing the text understanding analysis on the original search result so as to obtain a search result for displaying.

16. The device according to claim 13, wherein the second display module obtains a search result according to the query by:
obtaining a precise answer corresponding to a question using a deep question answering when the query is the question.

17. The device according to claim 13, wherein the second display module obtains a search result according to the query by:
determining multiple demand dimensions corresponding to the query when the query is a multi-demand query; and
aggregating the search results corresponding to the different demand dimensions so as to obtain an aggregate result.

18. The device according to claim 13, further comprising:
a modeling module, configured to perform a personalized modeling according to user information so as to obtain a personalized model, and/or, to perform a scene modeling according to the user information so as to obtain a scene model;
wherein the second display module obtains a search result according to the query by:
obtaining a precise result or an aggregate result according to the query;
obtaining a recommendation guide result corresponding to the precise result or the aggregate result according to one or more of information:
a relevance between a result to be recommended and the query, a relevance between the result to be recommended and the precise result or the aggregate result, a matching degree between the result to be recommended and the personalized model, a matching degree between the result to be recommended and the scene model, and a self-value feature of the result to be recommended.
